(19) United States
(12) Patent Application Publication
(10) Pub. No.: US 2026/0131597 A1
(43) Pub. Date: May 14, 2026

(54) KNUCKLE ASSEMBLY

(71) Applicant: ArvinMeritor Technology, LLC, Troy, MI (US)

(72) Inventors: Nicholas J. KELLY, Allen Park, MI (US); Bryan D. HACKETT, Davisburg, MI (US); Steven E. HUNTER, Lake Orion, MI (US)

(21) Appl. No.: 19/415,745

(22) Filed: Dec. 10, 2025

Related U.S. Application Data
(62) Division of application No. 18/916,392, filed on Oct. 15, 2024.

(51) Int. Cl. B60B 35/00; B60B 35/04; B62D 7/18

(52) U.S. Cl. CPC B60B 35/003; B60B 35/04; B62D 7/18; B60B 2310/20; B60B 2310/60; B60B 2900/211

(57) ABSTRACT

A knuckle assembly for a wheelend assembly of a vehicle is disclosed, having a spindle comprising an outboard end for receiving the wheelend assembly, an inboard end, and a spindle axis extending between the outboard end and the inboard end, and a flange portion extending radially from the spindle. A knuckle is cast about the inboard end of the spindle and may at least partially encapsulate the flange on an inboard side of the flange and an outboard side of the flange. Novel geometries for the knuckle and spindle, having different materials, are disclosed, along with a method of forming the knuckle assembly.

### TECHNICAL FIELD

The present disclosure relates to a knuckle assembly for a vehicle. Aspects of the invention relate to a knuckle assembly, and a vehicle comprising the knuckle assembly.

### BACKGROUND

It is known to provide knuckle assemblies for use in steering and suspension systems of vehicles. These typically include a knuckle body which has fixation points for mounting to a suspension assembly. Other fixation points may be included for fixation to a steering rack for example to provide a steering function. Such knuckle assemblies typically include a spindle portion, which extends in an outboard direction from a body of the knuckle assembly. The spindle portion is arranged to receive a wheel end assembly, including such components as hub, bearings and generally components which rotate in relation to the knuckle assembly.

The forces and structural constraints on the different components of the knuckle assembly can be different for each region of the assembly. Known methods of manufacture of knuckle assemblies teach particular features which place certain constraints on the manufacture of the knuckle assembly.

The present invention aims to address one or more of the disadvantages associated with the prior art.

### SUMMARY OF INVENTION

Aspects and embodiments of the invention provide a knuckle assembly for a wheelend assembly of a vehicle, and a vehicle comprising the knuckle assembly. All aspects address at least the problem of providing improved material selection by permitting the use of different materials for, and providing an improved connection interface between, a spindle and a knuckle in a knuckle assembly for a wheelend assembly of a vehicle.

According to a first aspect of the present invention, a knuckle assembly is provided, which may comprise any or all of the following features: a spindle, comprising: an outboard end for receiving a wheelend assembly, an inboard end, and a spindle axis extending between the outboard end and the inboard end; a flange portion extending radially from the spindle; a knuckle cast about the inboard end of the spindle and at least partially encapsulating the flange on an inboard side of the flange and an outboard side of the flange. The flange portion may extend radially from the spindle, and the knuckle may be cast around the spindle's inboard end, and may encapsulate the flange on both inboard and outboard sides.

The knuckle may encapsulate the inboard end of the spindle, for example leaving no part of the inboard end, on an inboard side of the knuckle exposed. The inboard end of the spindle may be at least partially encapsulated, such that movement is prohibited in any or all of: an inboard direction, an outboard direction, and/or a lateral direction, substantially perpendicular to a longitudinal axis of the spindle. The at least partial encapsulation may inhibit or prohibit rotational movement of the spindle relative to the knuckle. The at least partial encapsulation may inhibit or prohibit all lateral movement in any lateral direction, substantially perpendicular to a longitudinal axis of the spindle. The encapsulation may inhibit or prohibit all movement of the spindle relative to the knuckle. The arrangement may be such that relative movement between the spindle and the knuckle is only possible by deformation of the knuckle or the spindle. This can help to provide a more secure and integrated structure.

The spindle may comprise a first material and the knuckle may comprise a second material different from the first. The first material may have a greater strength and/or hardness than the second material.

The flange may comprise at least one outer surface feature arranged to engage the knuckle to prevent rotation of the spindle within the knuckle.

The knuckle assembly may further comprise a steering arm, which may be integrally cast with the knuckle.

The knuckle assembly may further comprise an oxidation inhibitor disposed at an interface between the spindle and the knuckle. The oxidation inhibitor may comprise one or more of: borax, and/or a borax solution.

In a further aspect, there is provided a knuckle assembly for a wheelend assembly of a vehicle, comprising: a spindle, comprising: an outboard end for receiving a wheelend assembly, an inboard end, and a spindle axis extending between the outboard end and the inboard end; a knuckle cast about the inboard end of the spindle; and an oxidation inhibitor disposed at an interface between the spindle and the knuckle.

The oxidation inhibitor may comprise one or more of: borax, and/or a borax solution.

In a further aspect, there is provided a knuckle assembly for a wheelend assembly of a vehicle, comprising: a spindle, comprising: an outboard end for receiving a wheelend assembly, an inboard end, and a spindle axis extending between the outboard end and the inboard end; and a knuckle, disposed at the inboard end of the spindle, comprising: a knuckle body disposed about the inboard end of the spindle, the inboard end of the spindle received in the knuckle body; and a pivot point extension member, extending inboard from the knuckle end and toward the spindle axis, such that a virtual cylindrical extension of the spindle in the inboard direction coincides with at least a part of the pivot point extension member; or: at least a part of the knuckle extending inboard from the knuckle end and toward the spindle axis, such that a virtual cylindrical extension of the spindle in the inboard direction coincides with the part of the knuckle extending inboard from the knuckle end and toward the spindle axis. Prior manufacturing techniques have not permitted a spindle of different, optionally relatively harder or stronger, materials to be provided in a knuckle in which a virtual cylindrical extension of the spindle in the inboard direction coincides with at least a part of the knuckle, such as a pivot point extension member. Past techniques involved insertion of the spindle from the inboard side of a preformed knuckle, rendering it impossible to have a structure in which a virtual cylindrical extension of the spindle of the assembly in the inboard direction coincides with at least a part of the knuckle, such as a pivot point extension member, because the insertion of the spindle from the inboard side would be prohibited.

The pivot point extension member, or other part of the knuckle that coincides with a virtual cylindrical extension of the spindle in the inboard direction, may comprise at least one mounting point for mounting the knuckle to a vehicle or a vehicle sub-assembly, such as an axle.

The knuckle assembly may further comprise an oxidation inhibitor disposed at an interface between the spindle and the knuckle. One or more of the above aspects may be comprised in a vehicle.

A further aspect provides a method of forming a knuckle assembly for a wheelend assembly of a vehicle, the method comprising the steps of: providing a spindle, comprising an outboard end for receiving a wheelend assembly, an inboard end, a spindle axis extending between the outboard end and the inboard end, and a flange portion extending radially from the spindle; and casting a knuckle about the inboard end of the spindle and at least partially encapsulating the flange on an inboard side of the flange and an outboard side of the flange.

The method may further comprise the step of applying a surface treatment to the inboard end of the spindle prior to casting the knuckle about the inboard end of the spindle.

The method may further comprise the step of performing a material forming or removal process on the inboard end of the spindle prior to casting the knuckle about the inboard end of the spindle.

The step of applying a surface treatment to the inboard end of the spindle may comprise applying an oxidation inhibitor to the surface of the spindle. The surface treatment may comprise Borax.

The method may further comprise preheating the spindle prior to casting the knuckle. The method may further comprise casting a steering arm integrally with the knuckle.

The method may further comprise providing a mould for casting the knuckle, the mould comprising removable tooling for providing a cavity for casting the steering arm integrally with the knuckle, such that the removable tooling can be changed to provide steering arms of alternative configurations.

Within the scope of this application, it is expressly intended that the various aspects, embodiments, examples and alternatives set out in the preceding paragraphs, in the claims and/or in the following description and drawings, and, in particular, the individual features thereof, may be taken independently or in any combination. All embodiments or aspects and/or features of any embodiment or aspect can be combined in any way and/or combination unless such features are incompatible. The applicant reserves the right to change any originally filed claim or file any new claim accordingly, including the right to amend any originally filed claim to depend from and/or incorporate any feature of any other claim, although not originally claimed in that manner.

Further benefits and advantages of the present invention will become apparent from the following detailed description of at least one exemplary embodiment for carrying out the present invention with reference to the accompanying drawings.

### BRIEF DESCRIPTION OF DRAWINGS

One or more embodiments of the invention will now be described, by way of example only, with reference to the accompanying drawings, in which:

FIG. 1 is a vehicle into which a knuckle assembly as disclosed may be incorporated;

FIG. 2 is a first perspective view of a knuckle assembly as disclosed;

FIG. 3 is a second perspective view of a knuckle assembly as disclosed;

FIG. 4 is a cross section through a knuckle assembly as disclosed;

FIG. 5 is a cross section illustrating a casting apparatus as disclosed;

FIG. 6 is a flow diagram for a method as disclosed.

### DETAILED DESCRIPTION

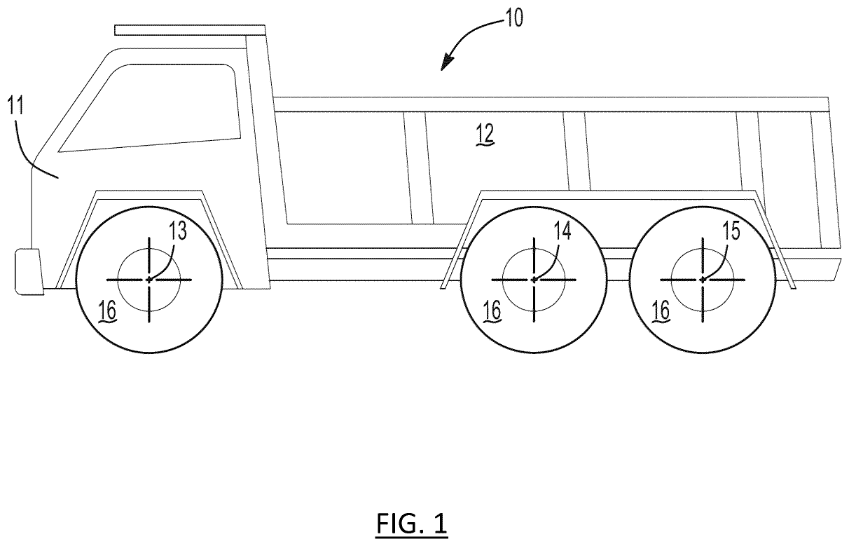

FIG. 1 illustrates a vehicle 10 into which a knuckle assembly according to the present disclosure may be integrated. The vehicle has a cab 11 and may incorporate a cargo or passenger carrying region 12. While FIG. 1 illustrates a cargo or passenger-carrying vehicle, the knuckle assembly of the present disclosure can be incorporated into any suitable type of vehicle requiring a knuckle assembly of the kind described herein. Connection of a knuckle assembly to each wheel 16 of the vehicle may be desirable. A knuckle assembly can be incorporated into one or more wheel end assemblies 13, 14, 15 of the vehicle 10 in order to mount a wheel 16. Knuckle assemblies can be incorporated into non-steerable or partially steerable wheels 14, 15. A knuckle assembly as disclosed herein can be provided as a steering knuckle to mount steerable wheels 13.

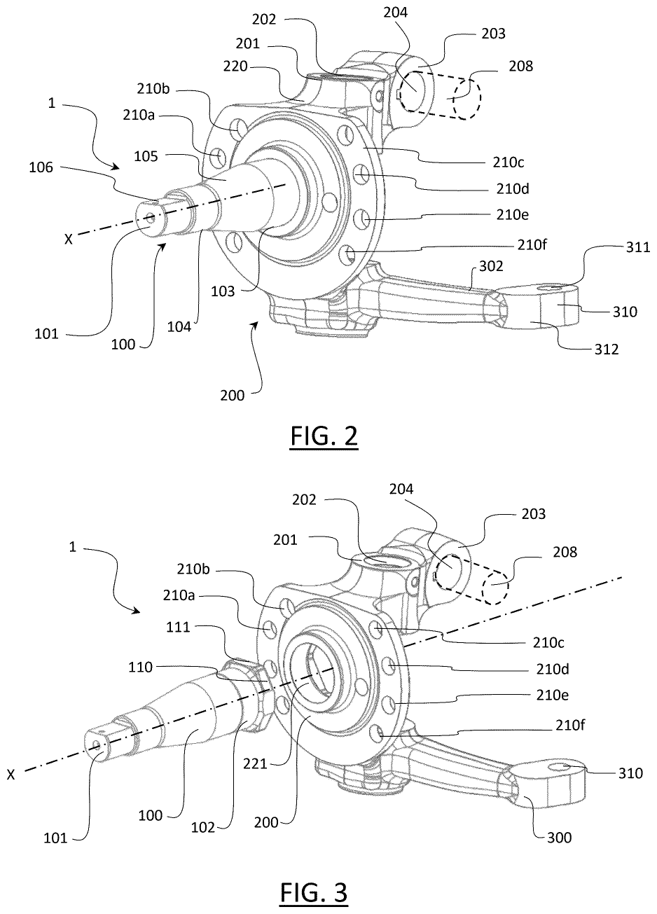

With reference to FIG. 2, a knuckle assembly of the present teachings is indicated generally at 1. Various orientations of the knuckle assembly are described. In particular, the directions inboard I and outboard O refer to the typical orientation of the knuckle assembly when fitted to a vehicle and with reference to the longitudinal centreline of the vehicle. The radial direction R refers to an orientation with reference to the centre of a spindle (axis X).

The knuckle assembly 1 is arranged and configured for incorporation with a wheel end assembly of a vehicle. The knuckle assembly comprises a spindle 100. The spindle may comprise a spindle axis X extending between an outboard end 101 and an inboard end 102 of the spindle. The knuckle assembly further comprises a knuckle 200. The knuckle 200 is arranged to be incorporated into a suspension assembly of a vehicle. The illustrated example is for incorporation into a steerable assembly, but similar could be formed according to the principles and methods described herein non-steerable wheel assemblies. The knuckle comprises a knuckle body 220 which provides a structural element mounting the spindle 100 and any other components of the knuckle assembly to the vehicle. The knuckle 200 may further comprise one or more mounting portions 201, 203, 205, for mounting the knuckle to a vehicle, which may be done via other intermediate suspension components, such as an axle 400. The one or more mounting portions 201, 203, 205, may comprise one or more respective mounting bores 202, 204, 206. One such mounting portion, for example mounting portion 203, may be for mounting a steering arm to receive steering inputs. One or more further mounting portions 201, 205, may provide a pivot point such that the knuckle 1 may pivot about a pivot axis P relative to an axle 400 to which the knuckle may be mounted in a steerable or pivotable manner.

The knuckle 200 may further comprise mounting points or holes 210a, 210b, 210c, 210d, 210e, 210f, for mounting equipment to, such as braking assemblies, sensors or actuators, for example.

The knuckle 200 may comprise a tie rod arm 300. The tie rod arm 300 may project or extend laterally from the knuckle 200, for example in a direction at least partially perpendicular to an axis X of the spindle. The tie rod arm 300 may comprise an elongate body portion 302. The tie rod arm 300 may further comprise a tie rod arm engagement end 310 comprising an engagement point 311 for engaging a tie rod in an assembly on a vehicle to which the knuckle assembly may be mounted, for example to connect the knuckle to a further knuckle on the vehicle to transfer steering inputs between the respective knuckles. The tie rod arm 300 may comprise at least a portion that is a cast part of the knuckle.

The spindle 100 comprises an inboard end 102 and an outboard end 101. The spindle is of standard configuration for a vehicle towards its outboard end, and may comprise one or more cylindrical portions 103, 104, of different diameters, one or more tapered portions 105 adjacent or in between such cylindrical portions and other features may be provided for fixing or mounting a wheel end assembly to the spindle, such as a flat 106.

FIG. 3 shows the spindle 100 separately from the knuckle 200 in order to illustrate their engagement. When manufactured, the spindle 100 will be disposed within the bore 221 of the knuckle 200. The spindle may comprise a flange portion 110. The flange portion 110 is configured to extend radially from the spindle and can assist with resisting pull-out of the spindle 100 from the knuckle 200. The flange portion 110 may be provided with one or more anti-rotation features. Such features may be non-circular radially outer surface features or portions 111 to resist rotation of the spindle 100 within the knuckle 200. Such features could be a flat or polygonal radially outer surface feature, or a recess or protrusion on the surface, which may otherwise be circular or cylindrical.

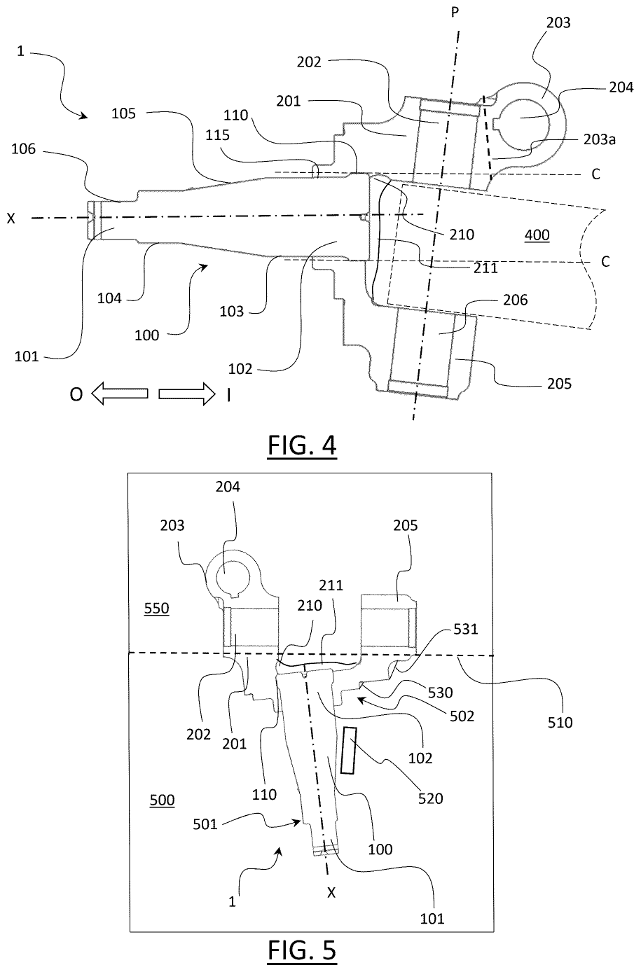

An example of the knuckle assembly disclosed is shown in cross-section in FIG. 4. The spindle 100 is received within the bore 221 of the knuckle 200. The knuckle 200 may be cast about the spindle 100 in a process which will be described later in this description. As can be seen, the knuckle body 220 may at least partially envelop one or more of the inboard end 102 and the flange portion 110 of the spindle 100. In some examples, the knuckle body 220 may be formed with an end covering portion 211 which completely envelops the inboard end 102 of the spindle 100. At least partial covering of the inboard end and/or flange 110 of the spindle 100 with the overcast knuckle body 220 can assist with resisting push through of the spindle in the inboard direction and can assist with securing the spindle within the knuckle body 220.

As can be seen in FIG. 4, the arrangement of the knuckle body 220 and the mounting portion 201 is such that the spindle 101 could not be inserted into the bore 221 from the inboard (I) side of the knuckle body 220. The chosen geometry of the knuckle, and the axle number 400 to which it is mounted, and the desired angle of the pivot axis P, can mean that a geometry is required which does not permit insertion of the spindle 100 into the bore 221 from an inboard (I) side of the knuckle 200. For example, as can be seen in FIG. 4, a virtual cylindrical extension of the spindle in the inboard direction, as represented by lines C in FIG. 4, coincides with at least a part of the knuckle, such as the pivot point extension member, which may be provided by mounting portion 201. The pivot point extension member can be provided with a mounting point 202 for mounting the knuckle 200 to a vehicle. To provide a knuckle assembly with the desired geometry and mechanical properties, the inventors have devised an improved method of manufacturing a knuckle assembly as is described herein. Using the methods described herein, any part of the knuckle may coincide with a virtual cylindrical extension of the spindle in the inboard direction without inhibiting the secure provision of the spindle as a distinct component within the knuckle 200.

The inventors have identified that it can be advantageous to have a strong spindle 100, since load and stress concentrations can be highest in the spindle 100. On the other hand, a lightweight knuckle 200 can be advantageous, and it need not necessarily be made from as strong a material as the spindle 100, since greater mass and more load-efficient forms can be designed into the knuckle 200 as space constraints are lower for the knuckle 200, while the spindle 100 must necessarily have a relatively small diameter to fit within the wheel end assembly and its bearings etc. The inventors have therefore discerned that it can be advantageous to cast a knuckle 200 about a spindle 100 in a casting process. There are several factors to consider when designing such a process. One particular benefit of it is that an arrangement which would not permit insertion of a separate spindle 100 into the knuckle 200 from the inboard side can be formed, while still providing different materials for the spindle 100 and the knuckle 200.

It can be advantageous for the spindle 100 to comprise a first material having greater strength and/or hardness than a second material, of the knuckle 200. It can be beneficial for the knuckle 202 to comprise a material having a lower mass per unit volume than the spindle. In certain examples, the spindle 100 may comprise or be made from steel, for example forged steel. The knuckle 200 may comprise or be made from a material having higher ductility than that of the spindle 100. The knuckle 200 may comprise or be made from a material, which may be a ferrous material and which may comprise iron, such as ductile iron suitable for use in an iron casting process. More generally, the first material may have a higher density and may be heavier for a given sized component. This can render the aterial less suited to casting and better suited to forging. Machine tool wear in material removal processes can be higher for such materials. The second material may be less dense and may be better suited to casting. The second material may have a lower hardness and may present lower tool wear in material removal processes. The first material may have higher mechanical properties but may be less suited to casting. The second material may have lower mechanical properties, but may be less energy intensive and/or more economical to manufacture.

It can be advantageous to provide a chemical treatment to the spindle 100 to provide protection to it from any negative effects of the casting of the knuckle 200 about the inboard end 102 of the spindle. Spindle 100 may therefore comprise a chemical treatment applied to its surface. The chemical treatment may include an oxidation inhibitor, which may be provided in particular at an interface 115 between the spindle 100 and/or flange 110 and the knuckle 200. One example of an oxidation inhibitor is Borax. Borax is a known material commonly available in powder or granular form and it may be applied to the surface of the spindle 100 as a solution. Other commercially available oxidation inhibitors may be employed at the interface 115 between the spindle and the knuckle.

Further, a surface treatment such as a physical process may be applied to the spindle 100 prior to forming the knuckle 200 about the spindle 100. Such a surface treatment may include any physical process which provides features enabling the spindle to better mate with the material of the knuckle 200 formed around it. This may include roughening the surface, providing variations in surface profile, such as by peening, or machining recesses, projections or grooves or channels into the surface of the spindle 100. Such features may therefore be provided at an interface 115 between the spindle 100 and the knuckle 200.

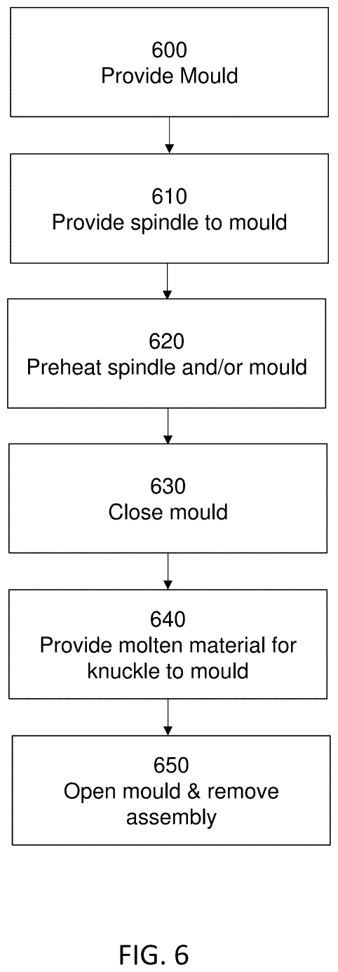

A method for forming a knuckle assembly as disclosed is now described in relation to FIG. 5 and the flow diagram of FIG. 6.

In a first step 600, a mould 500 is provided. The mould comprises at least one cavity, having a first part 501 for receiving the preformed spindle 100. The cavity can be provided with a second part 502 comprising a void arranged to form at least a portion of the knuckle 200. The void and the knuckle may be provided with suitable draft angles and/or chamfers 530, 531 in the usual way to enable the moulded part to be withdrawn from the mould after casting.

In step 610 the spindle 100 is provided to the mould. In step 620, which may come before step 610 depending on how the spindle is heated, the spindle may be preheated in the mould, for example if heating means 520, such as a resistive heater or other heating device, is provided. Alternatively, the spindle may be preheated elsewhere by another separate heating device before being provided to the mould 500. The preheating can be carried out such that the spindle is at a temperature of around 900 degrees celsius (around 1700 Fahrenheit). The temperature of the molten material moulded around the spindle may be around 1400 celsius (around 2600 Fahrenheit). Certain ranges around these values, such as plus or minus 10% or 20%, can help to achieve a balance between adequate heating of the spindle versus limitations in heating capacity, a desire to limit energy consumption in the heating process to reasonable levels, or avoiding negative effects of over-heating. In some examples, heating the spindle to above half the temperature of the molten material to be poured can be advantageous. Heating above around two thirds of the temperature of the molten material to be poured can be advantageous. Overheating of the spindle can cause problems or change the properties of the material of the spindle in an undesirable way, and so an upper limit on heating may also be advantageous. Suitable ranges may include heating the spindle to a temperature in the range from around half of the temperature of the molten material to be poured, up to 9/10 of the temperature of the molten material to be poured. Alternative upper bounds of the range may be around ⅘ (or around 80%), ¾ (or around 75%), ⅔ (around 66%) or ⅗ (around 60%) of the temperature of the molten material to be poured. Such limits or ranges can be applied as fractions or ranges relative to the example temperatures of the spindle and molten material described above.

In step 630 the mould is closed by applying the upper half 550 of the mould, to close the split mould, which is split along line 510. In step 640 molten material for forming the knuckle is provided to the mould and flows into the mould cavity and around at least a part of the spindle 100, such as the inner end 102 of the spindle and/or the flange 110.

In step 650 after a sufficient cooling time, the mould is opened and the assembly is removed. Any desired post moulding steps may be carried out, such as surface treatment of the knuckle and/or spindle, forming any desired bores in the knuckle 100, such as those described in relation to FIGS. 2 and 3, and potential drilling or reaming of the bores 202, 204, 206, for example.

In some arrangements, an attachment portion 203 is provided to attach a separate steering arm 208, as schematically shown in FIGS. 2 and 3, for receiving and transmitting steering input to the knuckle 200. In other arrangements, forming a steering arm 208 as schematically shown in FIGS. 2 and 3 can also form part of the over-moulding process. The steering arm 208 can be formed as an integral part of the overcast knuckle. Tooling for the mould 500/550 can be provided such that the tooling is removable and can be changed in order to provide different forms of steering arm for different product variants, as part of the cast knuckle. The material of the steering arm 208 may be the same as the cast knuckle 200 and can be integrally cast with the knuckle. The steering arm can be provided in a suitable cavity in the mould during the casting of the knuckle.

Where the word ‘or’ appears, this is to be construed to mean ‘and/or’. This is such that items referred to are not necessarily mutually exclusive and may be used in any appropriate combination.

The invention has been described above with reference to one or more specific embodiments. However, the description is not exhaustive, and the present invention is not limited to the embodiments described. Various changes and modifications can be made without departing from the scope of the invention as defined in the claims.

1. A method of forming a knuckle assembly for a wheelend assembly of a vehicle, the method comprising the steps of:
providing a spindle, comprising an outboard end for receiving the wheelend assembly, an inboard end, a spindle axis extending between the outboard end and the inboard end, and a flange portion extending radially from the spindle; and
casting a knuckle about the inboard end of the spindle and at least partially encapsulating the flange portion on an inboard side of the flange portion and an outboard side of the flange portion,
wherein, when the knuckle is cast about the inboard end of the spindle, the spindle is heated to above half a temperature of molten metal used to form the knuckle.

2. The method of claim 1, further comprising the step of applying a surface treatment to the inboard end of the spindle prior to casting the knuckle about the inboard end of the spindle.

3. The method of claim 1, further comprising the step of performing a material forming or removal process on the inboard end of the spindle prior to casting the knuckle about the inboard end of the spindle.

4. The method of claim 2, wherein the step of applying a surface treatment to the inboard end of the spindle comprises applying an oxidation inhibitor to the surface of the spindle.

5. The method of claim 2, wherein the surface treatment comprises Borax.

6. The method of claim 2, further comprising the steps of:
casting a steering arm integrally with the knuckle.

7. The method of claim 2, further comprising providing a mould for casting the knuckle, the mould comprising removable tooling for providing a cavity for casting the steering arm integrally with the knuckle, such that the removable tooling can be changed to provide steering arms of alternative configurations.

8. The method of claim 2, further comprising preheating the spindle prior to casting the knuckle.

9. The method of claim 1, further comprising, prior to casting the knuckle, heating the spindle to no more than 90% of the temperature of the molten metal used to form the knuckle.

10. The method of claim 9, further comprising, prior to casting the knuckle, heating the spindle to no more than 80% of the temperature of the molten metal used to form the knuckle.

11. The method of claim 10, further comprising, prior to casting the knuckle, heating the spindle to no more than 75% of the temperature of the molten metal used to form the knuckle.

12. The method of claim 11, further comprising, prior to casting the knuckle, heating the spindle to no more than 66% of the temperature of the molten metal used to form the knuckle.

13. The method of claim 12, further comprising, prior to casting the knuckle, heating the spindle to no more than 60% of the temperature of the molten metal used to form the knuckle.

14. A vehicle comprising the knuckle assembly formed according to the method of claim 1.
